(19) United States
(12) Patent Application Publication
(10) Pub. No.: US 2024/0391114 A1
(43) Pub. Date: Nov. 28, 2024

(54) DEVICE FOR CONNECTING AN EFFECTOR OF A HANDLING DEVICE TO A ROBOT ARM

(71) Applicant: BLUE DANUBE ROBOTICS GMBH, Wien (AT)

(72) Inventors: Florian DANNEREDER, Würmla (AT); Andreas BALDINGER, Wien (AT); Tobias FERNER, Wien (AT); Walter WOHLKINGER, Wien (AT); Michael ZILLICH, Wien (AT)

(73) Assignee: BLUE DANUBE ROBOTICS GMBH, Wien (AT)

(21) Appl. No.: 18/694,194

(22) PCT Filed: Nov. 10, 2021
(86) PCT No.: PCT/IB2021/060389

§ 371 Date: Mar. 21, 2024

(30) Foreign Application Priority Data
Sep. 21, 2021 (AT) A 156/2021

(51) Int. Cl. B25J 15/04

(52) U.S. Cl. CPC B25J 15/0408

(57) ABSTRACT

In a device for connecting an effector of a handling device to a movable part of the handling device, in particular to a robot arm, wherein the device comprises a first mounting part for mounting the effector on the device and a second mounting part for mounting the device on the movable part and the first mounting part and the second mounting part are displaceable with respect to one another along a linear displacement path between a pulled-apart position and a pushed-together position, the first mounting part and the second mounting part are loaded with respect to one another along the displacement path with a settable restoring force, preferably with a constant restoring force along the displacement path, in the direction of the pushed-together position.

### CROSS-REFERENCE TO RELATED APPLICATIONS

The present application is a national phase application of PCT Application No. PCT/IB2021/060389, filed Nov. 10, 2021, entitled “DEVICE FOR CONNECTING AN EFFECTOR OF A HANDLING DEVICE TO A ROBOT ARM”, which claims the benefit of Austrian Patent Application No. A 156/2021, filed Sep. 21, 2021, each of which is incorporated by reference in its entirety.

### BACKGROUND OF THE INVENTION

### 1. Field of the Invention

The present invention relates to a device for connecting an effector of a handling device to a movable part of the handling device, in particular to a robot arm, wherein the device comprises a first mounting part for mounting the effector to the device and a second mounting part for mounting the device to the movable part, and the first mounting part and the second mounting part are displaceable relative to each other along a linear displacement path between a pulled-apart position and a pushed-together position.

### 2. Description of the Related Art

Handling devices within the meaning of the present invention are understood to be stationary or autonomously moving devices such as robots, in particular industrial robots, manufacturing robots, transport robots, inspection robots or service robots, which are increasingly being used. The handling devices are connected with one of their moving parts, such as a robot arm, to a so-called effector that can carry out the desired activity. An effector can therefore be a robotic hand for gripping objects or a vacuum holding element or even an attachment for welding, particularly in the automotive industry and related sectors. As a rule, the robot arm and the effector together have a considerable weight, which is of course increased by the load that is gripped and, given the sometimes high speeds involved in moving the effector and possibly the load in the event of a collision, entails a high risk of injury.

As such handling devices or robots become more widespread, there is an increasing need to protect people and stationary or autonomously moving obstacles from sometimes high forces in the event of a collision in order to prevent the destruction of objects and, in particular, injuries to people. For this purpose, it is already known to connect the effector by means of a device for connecting an effector of a handling device to a movable part of the handling device, which can also be referred to as a flange, which device provides a certain compliance in the event of a collision in order to prevent injury at the first moment of the collision before the handling device can be stopped automatically when the collision is detected.

The disadvantage of the known devices up to now was that it was not possible to adjust the compliance to adapt it to the weight of the effector and, if necessary, the payload.

### SUMMARY OF THE INVENTION

The present invention is therefore based on the task of providing a device of the type mentioned at the beginning, in which a restoring force can be set and preferably kept constant and ensured over the entire spring travel or deflection path.

To solve this problem, a device of the type mentioned at the beginning is characterized according to the invention in that the first mounting part and the second mounting part are loaded along the displacement path with an adjustable restoring force, preferably with a constant restoring force along the displacement path, in the direction of the pushed-together position relative to one another.

By providing an adjustable restoring force, preferably a constant restoring force along the displacement path, with the device according to the invention, which is also referred to herein as a flange, injuries and damage to persons and stationary or autonomously moving obstacles can be avoided.

According to a preferred embodiment of the present invention, a spring mechanism with at least a first spring and a second spring applies the adjustable restoring force, wherein the first spring is brought into action with decreasing restoring force in the direction of the pushed-together position and the second spring is brought into action with increasing restoring force in the direction of the pushed-together position. To make this possible, the springs do not act directly on the first and second mounting parts, but form spring units together with corresponding converting elements, which make it possible to increase the resulting restoring force of the respective spring unit when the respective spring is deformed, which is inevitably accompanied by a decrease in the actual spring force, so that the decreasing spring force is compensated for. A converting element forms a transmission element to a certain extent, which ensures a suitable transmission of the spring force.

In a preferred manner, the present invention is characterized in that at least one converting element is provided for converting a displacement movement along the displacement path into an actuation of the first and/or the second spring transverse to the displacement path. This means that the spring acts on an inclined or curved plane formed by the converting element, resulting in a transformation or conversion of the resulting force direction of the spring unit. By converting the displacement movement along the displacement path into an actuation of the first and/or second spring transverse to the displacement path, the device according to the invention can be constructed in a compact manner in order to cope with confined spaces. At the same time, conversion by the converting elements makes it possible to compensate or even overcompensate for a decreasing spring force due to the relaxation of a spring when the two mounting elements are displaced in relation to each other.

With regard to the arrangement of the first spring, which provides a conventionally decreasing restoring force with increasing expansion of the spring, it is provided according to a preferred embodiment of the present invention that the first spring is fixed with respect to its direction of action in the direction of the displacement path between a bearing on one of the first and second mounting parts and a first contact element on the other of the first and second mounting parts. This means that the spring is inserted between the first and second mounting parts in the direction of the displacement path and, as it expands with the associated decrease in spring force or restoring force, presses the two mounting parts in the direction of the pushed-together position. The first spring thus supports the deflection of the device according to the invention in the event of a collision, whereby the restoring force can be adjusted either by selecting a suitable spring constant or preferably by pretensioning the spring accordingly. The preload of the spring can be changed simply by changing the distance between the bearing and the contact element. This provides an already initially effective compliance of the device.

In a preferred alternative arrangement of the first spring, the direction of action of the first spring is reversed as described above. This also provides an already initially effective compliance of the device. Preferably, the device according to the invention is designed in such a way that a first converting element has a first contact surface for the first spring, which is flat and inclined in relation to the displacement path. As a result, the first spring is also used linearly, but transversely to the direction of the displacement path, so that a lower overall height can be achieved with respect to the first spring in this variant of the present invention. This design also makes it possible, for example, to easily preload the first spring from the side of the device, i.e. at right angles to the direction of the displacement path, making it easier to adjust the preload when the flange is installed.

Overall, with regard to the first spring unit consisting of spring and converting element, the device is therefore characterized in the preferred variant just described with a first converting element which has a first contact surface for the first spring which is inclined and straight in relation to the displacement path, in that the first spring acts transversely or obliquely to the displacement path and interacts with the first contact surface of the first converting element for the first spring, which contact surface is formed with a constant slope along the displacement path in the direction of the pushed-together position, the first spring pressing against the first contact surface and the first spring being fixed to one of the first and second mounting parts and the first converting element being fixed to the other of the first and second mounting parts.

In order to compensate for the decreasing spring force of the first spring during expansion, i.e. when the two mounting parts are displaced in the direction of the pushed-together position, the invention is preferably further developed in that a second converting element has a second, curved contact surface for the second spring in order to provide an increasing force effect with increasing displacement. This means that the second spring acts on a contact surface of the second converting element, which has an increasingly steeply sloping contour when the first mounting part is displaced towards the second mounting part in the direction of the pushed-together position, so that despite the decreasing compressive force of the second spring with increasing expansion of the second spring, the spring unit consisting of the second spring and the second converting element has an increasingly stronger restoring force overall in the direction of the displacement path. In this way, it is possible to bring the first and second springs into action in such a way that a constant restoring force is achieved over the entire displacement path with basically the same direction of action of the two spring units, namely in the direction of the pushed-together position and thus that position which is to be assumed by the device according to the invention due to a collision. This leads to excellent evasive behavior of the device according to the invention in the event of a collision and thus to a significantly reduced risk of damage or injury in the event of a collision.

At the same time, it is preferable that the second, curved contact surface is designed to provide a decreasing force in the direction of the displacement path as the compression of the second spring increases. This means that the curve of the second contact surface in the contact area of the second spring on the second contact surface in the extended position of the device according to the invention ensures that the second spring in this position has hardly any influence on the evasive behavior of the device according to the invention and only comes into play when the restoring force of the first spring decreases. In combination with the action of the first spring, this provides a constant restoring force.

Overall, with regard to the second spring unit consisting of the second spring and the second converting element, the device is preferably designed in both of the alternatives described above in such a way that the second spring acts transversely or obliquely to the displacement path and interacts with the second contact surface of the second converting element for the second spring, which is formed along the displacement path in the direction of the pushed-together position with increasing inclination, the second spring pressing against the second contact surface and the second spring being fixed to one of the first and second mounting parts and the second converting element being fixed to the other of the first and second mounting parts. In this way, it is possible to bring the second spring into action in such a way that, in the case of small dimensions of the device according to the invention, an effective compensation of the spring force of the first spring, which decreases when the device according to the invention deflects in the direction of the compressed position, takes place and the second spring or the second spring unit comes into action with an increasing effective component in the direction of the displacement path when the flange deflects.

For the easiest and quickest possible adjustment of the restoring force of the first spring, preferably for automatic adjustment of the restoring force of the first spring depending on the weight of the effector and possibly the load on the effector, the present invention is preferably characterized in that means are provided for displacing the first converting element, the means being formed by a spindle drive, preferably a motor-driven spindle drive. If the first converting element is displaced accordingly in accordance with this preferred embodiment, the first spring runs onto the contact surface of the first converting element independently of any deflection of the flange and is thereby compressed or relieved. As a result, the preload increases or decreases accordingly and the initial restoring force of the first spring or the first spring unit is changed accordingly.

Likewise, the second spring or the second spring unit can be preset accordingly with respect to its restoring force if means are provided for displacing the second converting element, the means being formed by a spindle drive, preferably a motor-driven spindle drive, as corresponds to a preferred embodiment of the present invention

In order to accomplish an adjustment of the restoring force without changing the ratio of the effects of the first spring with respect to the second spring, the present invention is preferably further embodied in that means are provided for jointly displacing the first converting element and the second converting element, wherein the means for jointly displacing are each formed by a motor-driven spindle drive for the first converting element and for the second converting element and by a control unit for jointly driving the two spindle drives. Both converting elements are thus displaced to the same extent, so that an unchanged ratio of the effective components in the displacement direction is maintained with a changed total restoring force and the device according to the invention will behave independently of the load of the effector or the load on the effector with regard to the displacement.

In order to prevent the device according to the invention from being pulled apart completely in the event of a very large load on the effector, the device according to the invention is preferably further designed in such a way that the displacement path of the first mounting part with respect to the second mounting part is limited in the pulled-apart position. For this purpose, corresponding stops are preferably provided, which can preferably also serve as a bearing or contact element for the first spring if the first spring is fixed with respect to its direction of action in the direction of the displacement path between a bearing on one of the first and second mounting parts and a first contact element on the other of the first and second mounting parts, as has been explained in connection with a preferred variant of the present invention already described.

In order to ensure that the first spring is mounted with as little friction as possible, the present invention is preferably further embodied in such a way that the first spring presses against the contact surface of the first converting element by means of a roller or a rolling ball.

Equally preferably and for the same purpose, the second spring can press against the contact surface of the second converting element by means of a roller or a rolling ball.

Naturally, the device according to the invention can only prevent the occurrence of an impermissibly high load in the event of a collision with objects or bystanders by means of a limited displacement path. If the entire displacement path is exhausted, further movement of the robot arm would result in damage or injury. The present invention is therefore preferably further embodied in that the device has a sensor device which is set up to output a control signal when the first mounting part is displaced relative to the second mounting part. As soon as a displacement occurs, the control signal is generated and the control signal can be immediately passed on to the robot controller, i.e. the handling device, to bring the handling device to a standstill.

Due to the usual speeds at which effectors of handling devices are moved, for example when placing a load on a surface and due to the expected duration to bring the handling device to a standstill, the displacement path has a length of 10 mm to 40 mm, preferably 15 mm to 35 mm, more preferably 20 mm to 30 mm and most preferably 25 mm, as corresponds to a preferred embodiment of the present invention.

### BRIEF DESCRIPTION OF THE DRAWINGS

The invention is explained in more detail below with reference to an embodiment shown in the drawing. Therein

FIG. 1 shows an overall view of a handling device with the device according to the invention and an effector mounted on it,

FIG. 2 shows an enlarged view of the device according to the invention,

FIG. 3 shows a perspective view of the device according to the invention from the side of the second mounting part,

FIG. 4 shows a perspective view of the device according to the invention from the side of the first mounting part,

FIG. 5a shows a sectional view of the device according to the invention in an pulled-apart or extended position,

FIG. 5b shows a sectional view of the device according to the invention in a pushed-together or collapsed position,

FIG. 6 shows a sectional view to illustrate the adjustment of the preload of the first and/or second spring and

FIG. 7 is a top view of the internal structure of the device according to the invention.

### DETAILED DESCRIPTION

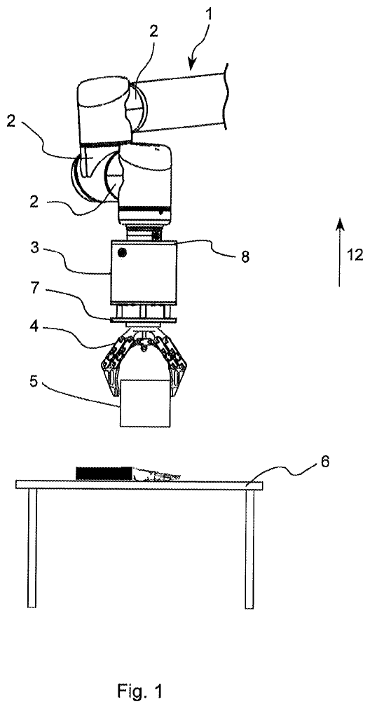

In FIG. 1, a moving part of a handling device, in this case a robot arm of a robot, such as an industrial robot, is designated by the reference sign 1. The robot arm 1 has a number of joints 2 with which the robot arm 1 can be rotated in all directions. The device according to the invention is designated by the reference sign 3 and is used to connect an effector 4, in this case a robot hand, to the robot arm 1. A load gripped by the robot hand 4 is designated by the reference sign 5 and the industrial robot has the task, for example, of placing the load 5 on the table top 6. In the event that the load 5 or the robot arm including the effector 4 or the load 5 collides for example with the hand of a person, the device 3 according to the invention is intended to ensure that the first mounting part 7 and the second mounting part 8 can be displaced towards each other along a linear displacement path, which is symbolized by the arrow 12, between a pulled-apart position and a pushed-together position, in order to minimize the risk of injury to the hand.

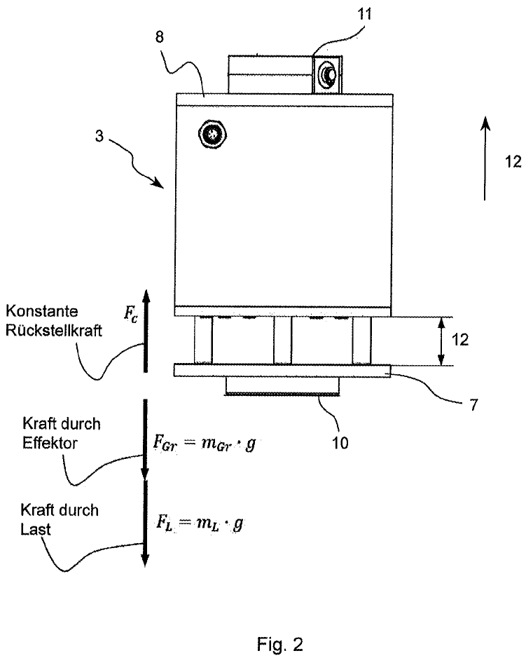

In FIG. 2 and the other figures, identical or corresponding parts are marked with the same reference signs. Again, the first mounting part 7 and the second mounting part 8 can be seen, the first mounting part having an interface 10 for the effector and the second mounting part having an interface 11 for the robot arm 1 in order to mount the effector 4 on the first mounting part 7 and the second mounting part 8 on the robot arm 1 of the device according to the invention. The arrows 12 indicate the displacement path of the device according to the invention, whereby the path has a length of 10 mm to 40 mm, for example. FIG. 2 also shows that the forces acting downwards are made up of the weight of the effector 4 and the weight of the load 5. These forces are countered by the adjustable restoring force of the flange 3 according to the invention, which is applied by a spring mechanism. Due to the effect of the restoring force of the flange 3 according to the invention, not the entire weight is applied when the load 4 is set down, so that, for example, a hand or arm of a person under the load is not loaded with this entire weight, so that injuries can be avoided. If the effector 4 continues to lower with the load 5, the flange 4 according to the invention springs in over the displacement path 12 until the robot can be stopped.

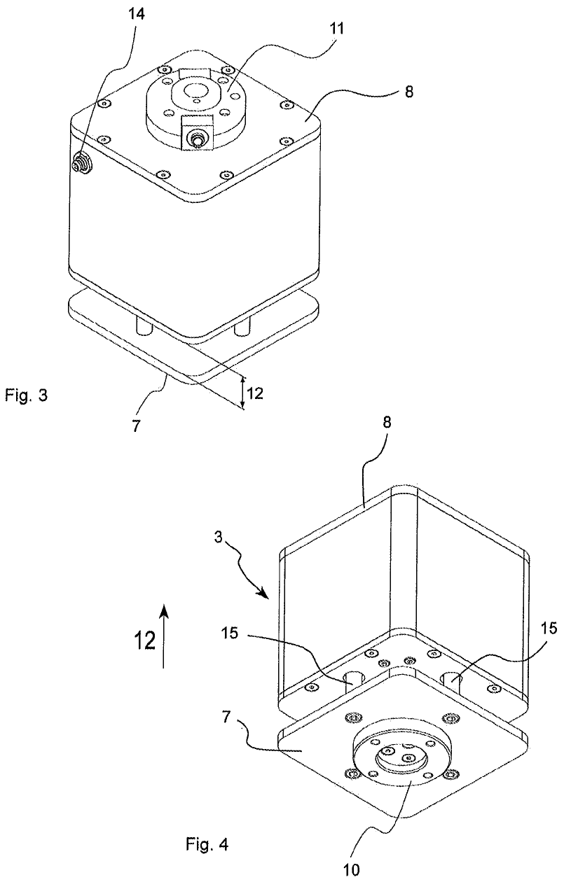

FIG. 3 shows the second interface 11 and an electronic interface 14 for robot control. If a displacement of the second mounting part 8 relative to the first mounting part 7 due to a collision is measured by a corresponding sensor, the robot can be stopped.

FIG. 4 shows that the first mounting part 7 interacts with the second mounting part 8 by means of rods 15 that plunge into the housing of the flange 3, with the plunging rods 15 defining the direction of the displacement path 12.

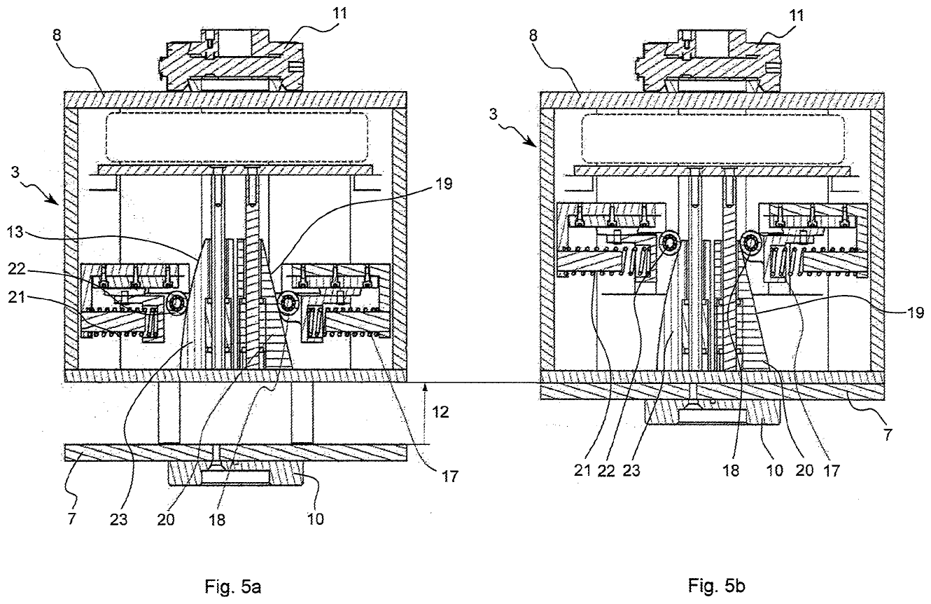

FIG. 5a shows the spring units of the flange 3 according to the invention, which provide the adjustable restoring force that is constant over the displacement path 12. A first spring is designated by the reference sign 17 and a second spring by the reference sign 21. The first spring 17 is mounted accordingly and presses on the contact surface 19 of a first converting element 20 via a roller 18. The first converting element 20 has a first contact surface 19 for the spring 17, which is inclined and flat in relation to the displacement path 12. The first mounting part 7 is coupled to the first spring 17. When the converting element 20 is displaced relative to the spring 17 or, in this example, the spring 17 relative to the converting element 20, the spring 17 is linearly relieved, resulting in a linearly decreasing restoring force by the first spring unit consisting of the first spring 17 and converting element 20. The second spring 21, which is also coupled to the first mounting part 7, acts with its roller 22 on a second, curved contact surface 13 of the second converting element 23, resulting in an increasing restoring force in the direction of the displacement path 12 even when the spring force decreases when the second spring 21 is released. In this way, the second spring unit consisting of the second spring 21 and second converting element 23 compensates for the decreasing restoring force of the first spring unit, resulting in an overall constant restoring force over the displacement path 12. The converting elements 20 and 23 are coupled to the second mounting part 8.

In FIG. 5b, it can be seen that when the first mounting part 7 is immersed in the direction of the displacement path 12 and towards the second mounting part 8, both springs 17 and 21 are released, but the second spring 21 applies a greater restoring force compared to the position in FIG. 5a due to its angle of attack on the second converting element 23.

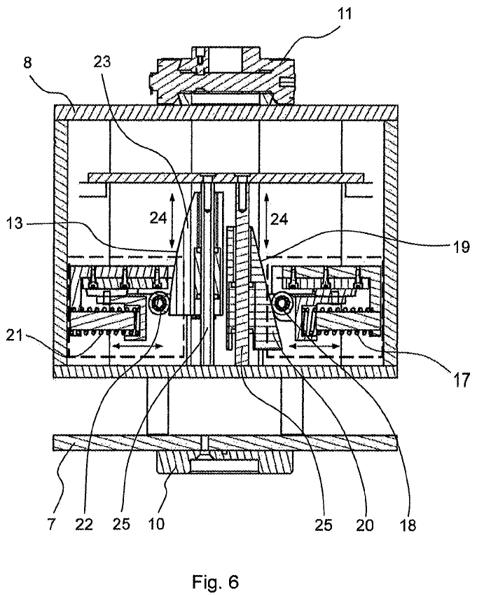

As shown in FIG. 6, the two converting elements 20 and 23 can be displaced along the direction shown by the double arrows 24 on threaded rods 25 of spindle drives relative to the second mounting part 8 in order to preload the springs 17 and 21 respectively, depending on the requirements. Due to the displacement of the converting elements 20 and 23, the springs 17 and 21 run with their rollers 18 and 22 to different degrees on the contact surfaces 19 and 13 of the converting elements 20 and 23, so that they are compressed or relieved to different degrees and are thus preloaded. As already explained, the converting elements 20 and 23 can also be moved together.

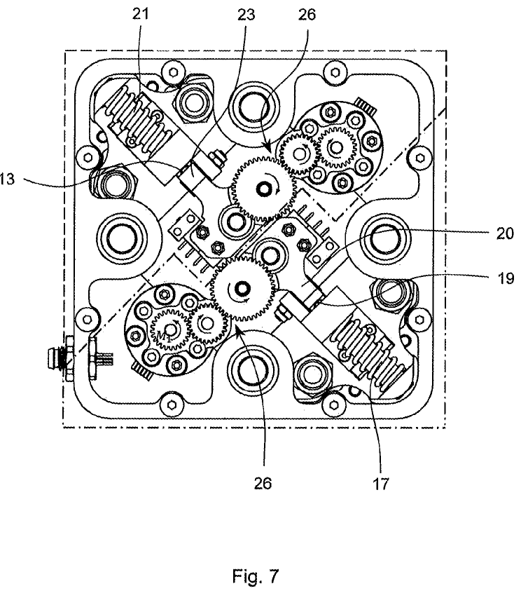

FIG. 7 shows that the converting elements 20 and 23 rest on the converting elements 20 and 23 by means of rollers 18 and 22. The converting elements can be moved by threaded rods driven by transmission 26 and corresponding electric motors 27, so that the springs 17 and 21 are preloaded accordingly.

1-17. (canceled)

18. A device for connecting an effector of a handling device to a movable part of the handling device, comprising:
a first mounting part for mounting the effector on the device; and
a second mounting part for mounting the device on the movable part, the first mounting part and the second mounting part being displaceable relative to one another along a linear displacement path between a pulled-apart position and a pushed-together position;
wherein the first mounting part and the second mounting part are loaded along the displacement path with an adjustable restoring force along the displacement path in a direction of the pushed-together position relative to one another.

19. The device according to claim 18, wherein the handling device is a robot arm.

20. The device according to claim 18, wherein the adjustable restoring force is a constant restoring force.

21. The device according to claim 18, wherein a spring mechanism with at least a first spring and a second spring applies the adjustable restoring force, the first spring being brought into action with decreasing restoring force in the direction of the pushed-together position and the second spring being brought into action with increasing restoring force in the direction of the pushed-together position.

22. The device according to claim 21, wherein at least one converting element is provided for converting a displacement movement along the displacement path into an actuation of at least one of the first spring transverse and the second spring transverse to the displacement path.

23. The device according to claim 21, wherein the first spring is fixed with respect to a further direction of action of the first spring in the direction of the displacement path between a bearing on one of the first and second mounting parts and a first contact element on the other of the first and second mounting parts.

24. The device according to claim 21, wherein a first converting element has a first contact surface for the first spring, the first contact surface being flat and inclined with respect to the displacement path.

25. The device according to claim 21, wherein:
the first spring acts transversely or obliquely to the displacement path and interacts with the first contact surface of the first converting element for the first spring, the first contact surface being formed with a constant gradient along the displacement path in the direction of the pushed-together position; and
the first spring presses against the first contact surface and the first spring is fixed to one of the first and second mounting parts and the first converting element is fixed to the other of the first and second mounting parts.

26. The device according to claim 21, wherein a second converting element has a second, curved contact surface for the second spring, the second converting element providing a force effect that increases with increasing displacement path.

27. The device according to claim 26, wherein the second, curved contact surface provides a decreasing force in the direction of the displacement path as a compression of the second spring increases.

28. The device according to claim 21, wherein:
the second spring acts transversely or obliquely to the displacement path and cooperates with the second contact surface of the second converting element for the second spring, the second contact surface being formed along the displacement path in the direction of the pushed-together position with increasing inclination; and
the second spring presses against the second contact surface and the second spring is fixed to one of the first and second mounting parts and the second converting element is fixed to the other of the first and second mounting parts.

29. The device according to claim 24, wherein means are provided for displacing the first converting element, the means being formed by a spindle drive.

30. The device according to claim 26, wherein means are provided for displacing the second converting element, the means being formed by a spindle drive.

31. The device according to claim 26, wherein:
means are provided for jointly displacing the first converting element and the second converting element; and
the means for jointly displacing are each formed by a motor-driven spindle drive for the first converting element and for the second converting element and by a control unit for jointly driving the two spindle drives.

32. The device according to claim 20, wherein the displacement path of the first mounting part is limited with respect to the second mounting part in the pulled-apart position.

33. The device according to claim 25, wherein the first spring presses against the contact surface of the first converting element by means of a roller or a rolling ball.

34. The device according to claim 26, wherein the second spring presses against the contact surface of the second converting element by means of a roller or a rolling ball.

35. The device according to claim 20, wherein the device has a sensor device which outputs a control signal when the first mounting part is displaced against the second mounting part.

36. The device according to claim 20, wherein the displacement path has a length of 10 mm to 40 mm.
